(19) United States
(12) Patent Application Publication
(10) Pub. No.: US 2017/0319013 A1
(43) Pub. Date: Nov. 9, 2017

(54) Hand Cleaning System

(71) Applicant: Jordan Guzman, Phelan, CA (US)

(72) Inventor: Jordan Guzman, Phelan, CA (US)

(21) Appl. No.: 15/146,239

(22) Filed: May 4, 2016

(51) Int. Cl. A47K 5/12; B05B 15/06; A47K 7/02

(52) U.S. Cl. CPC A47K 5/1202; A47K 7/02; B05B 15/061

(57) ABSTRACT

A hand cleaning system includes a soap dispenser that may be coupled to a support surface. The soap dispenser may contain and selectively dispense a measured amount of a fluid soap. Thus, a user may wash the user's hands. A pair of brushes is provided and each of the brushes is removably coupled to the soap dispenser. Each of the brushes may be manipulated when the user washes the user's hands. Thus, each of the brushes may scrub the user's hands. Each of the brushes is positioned on opposite sides of the soap dispenser with respect to each other.

### BACKGROUND OF THE DISCLOSURE

### Field of the Disclosure

The disclosure relates to cleaning devices and more particularly pertains to a new cleaning device for combining brushes with a soap dispenser.

### SUMMARY OF THE DISCLOSURE

An embodiment of the disclosure meets the needs presented above by generally comprising a soap dispenser that may be coupled to a support surface. The soap dispenser may contain and selectively dispense a measured amount of a fluid soap. Thus, a user may wash the user's hands. A pair of brushes is provided and each of the brushes is removably coupled to the soap dispenser. Each of the brushes may be manipulated when the user washes the user's hands. Thus, each of the brushes may scrub the user's hands. Each of the brushes is positioned on opposite sides of the soap dispenser with respect to each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a hand cleaning system according to an embodiment of the disclosure.

FIG. 2 is a top view of an embodiment of the disclosure.

FIG. 3 is a front view of an embodiment of the disclosure.

FIG. 4 is a back view of an embodiment of the disclosure.

FIG. 5 is a perspective in-use view of an embodiment of the disclosure.

### DESCRIPTION OF THE PREFERRED EMBODIMENT

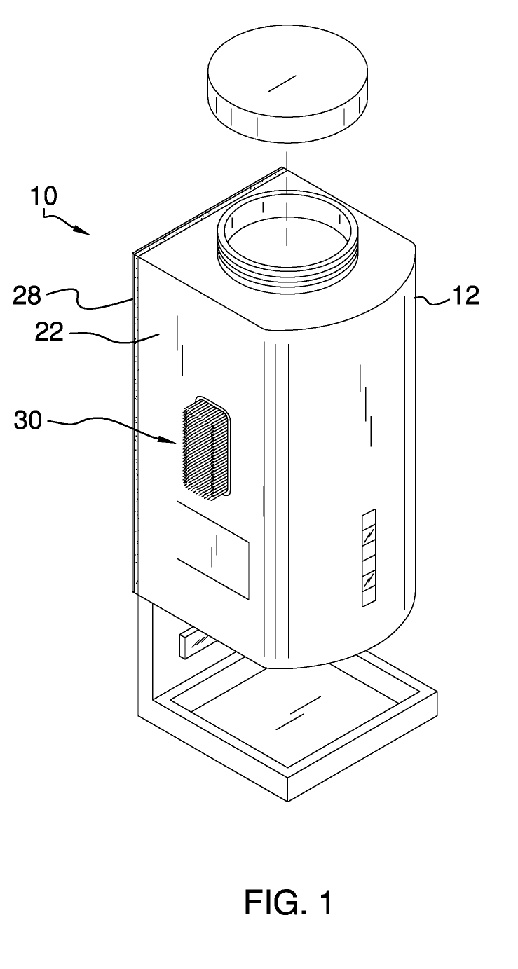

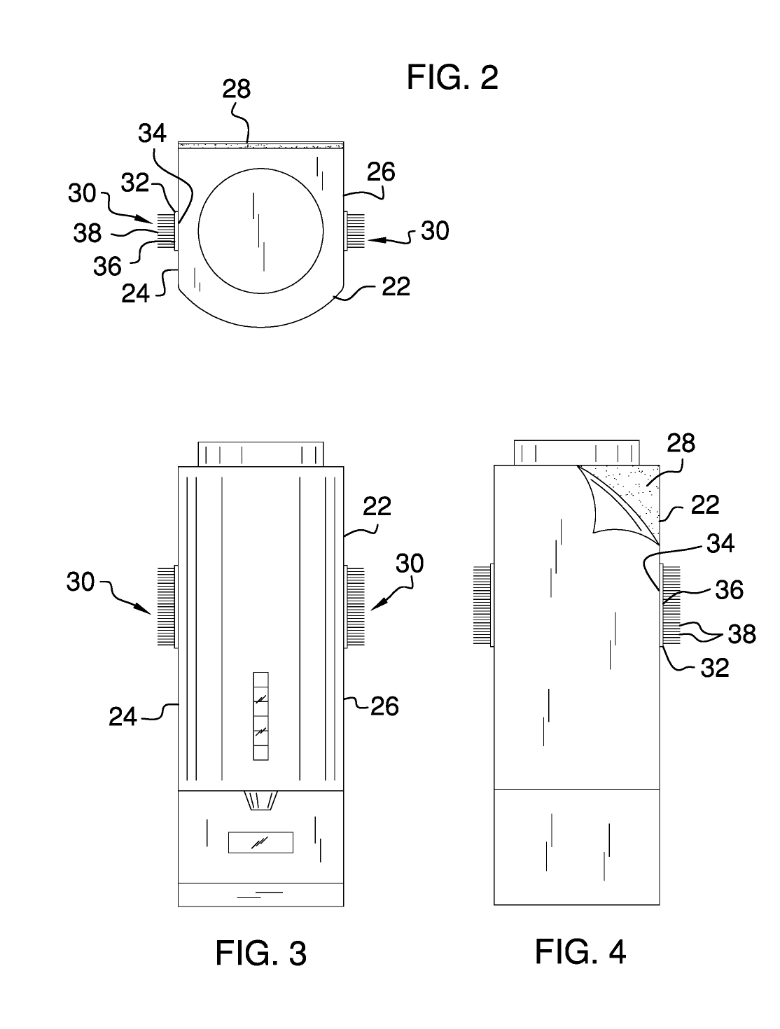

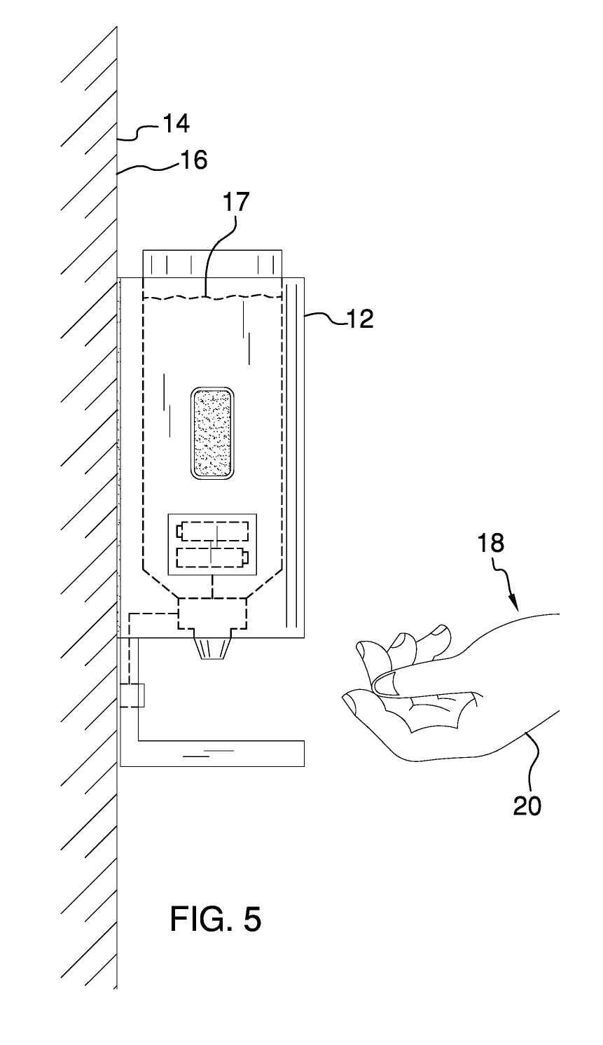

With reference now to the drawings, and in particular to FIGS. 1 through 5 thereof, a new cleaning device embodying the principles and concepts of an embodiment of the disclosure and generally designated by the reference numeral 10 will be described.

As best illustrated in FIGS. 1 through 5, the hand cleaning system 10 generally comprises a soap dispenser 12 that may be coupled to a support surface 14. The support surface 14 may be a wall 16 and the wall 16 may be located in an industrial setting or the like. The soap dispenser 12 may contain and selectively dispense a measured amount of a fluid soap 17. Thus, a user 18 may wash the user's hands 20.

The soap dispenser 12 may be a motion operated electrical soap dispenser or the like. Additionally, the soap dispenser 12 may be a manually operated soap dispenser or the like. The soap dispenser 12 has an outer wall 22. The outer wall 22 may have a first lateral side 24 and a second lateral side 26. A double sided tape 28 may be positioned on the outer wall 22. The double sided tape 28 may adhere to the support surface 14.

A pair of brushes 30 is provided and each of the brushes 30 is removably coupled to the soap dispenser 12. Each of the brushes 30 may be manipulated when the user 18 washes the user's hands 20. Thus, each of the brushes 30 may scrub the user's hands 20. Each of the brushes 30 may scrub beneath the user's finger nails. Thus, grease, oil or other contaminants may be cleaned from beneath the user's finger nails.

Each of the brushes 30 comprises a panel 32 that has a first surface 34 and a second surface 36. The first surface 34 is removably coupled to the outer wall 22 of the soap dispenser 12. A plurality of bristles 38 is coupled to the second surface 36. Each of the bristles 38 may frictionally engage the user's hands 20. The bristles 38 are spaced apart from each other and are distributed on the second surface 36.

In use, the soap dispenser 12 is manipulated in the convention of soap dispensers. The user 18 washes the user's hands 20 with the fluid soap 17 dispensed from the soap dispenser 12. The user 18 scrubs each of the user's hands 20 against an associated one of the brushes 30. Moreover, the user 18 scrubs the user's fingertips against the bristles 38 on the associated brush 30. Thus, the bristles 38 clean beneath the user's fingernails.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hand cleaning system comprising:
a soap dispenser being configured to be coupled to a support surface, said soap dispenser being configured to contain and selectively dispense a measured amount of a fluid soap thereby facilitating a user to wash the user's hands; and
a pair of brushes, each of said brushes being removably coupled to a respective vertically oriented face of said soap dispenser wherein each of said brushes is configured to be manipulated when the user washes the user's hands thereby facilitating each of said brushes to scrub the user's hands, each of said brushes being positioned on opposite sides of said soap dispenser with respect to each other, each of said brushes extending perpendicularly from said soap dispenser.

2. The system according to claim 1, wherein:
said soap dispenser has an outer wall; and
each of said brushes comprises a panel having a first surface and a second surface, said first surface being removably coupled to said outer wall of said soap dispenser.

3. The system according to claim 1, wherein each of said brushes comprises:
a panel having a first surface and a second surface; and
a plurality of bristles, each of said bristles being coupled to said second surface wherein each of said bristles is configured to frictionally engage the user's hands, said bristles being spaced apart from each other and being distributed on said second surface.

4. A hand cleaning system comprising:
a soap dispenser being configured to be coupled to a support surface, said soap dispenser having an outer wall, said soap dispenser being configured to contain and selectively dispense a measured amount of a fluid soap thereby facilitating a user to wash the user's hands; and
a pair of brushes, each of said brushes being removably coupled to a respective vertically oriented face of said soap dispenser extending perpendicularly from said soap dispenser wherein each of said brushes is configured to be manipulated when the user washes the user's hands thereby facilitating each of said brushes to scrub the user's hands, each of said brushes comprising:
a panel having a first surface and a second surface, said first surface being removably coupled to said outer wall of said soap dispenser, and
a plurality of bristles, each of said bristles being coupled to said second surface wherein each of said bristles is configured to frictionally engage the user's hands, said bristles being spaced apart from each other and being distributed on said second surface.
